(19) United States
(12) Patent Application Publication
(10) Pub. No.: US 2004/0011840 A1
(43) Pub. Date: Jan. 22, 2004

(54) Rolling motorcycle bag

(76) Inventor: Terry E. Lovett, Santa Ana, CA (US)

Correspondence Address: Albin H. Gess, Price and Gess, Suite 250, 2100 S.E. Main Street, Irvine, CA, 92614-6238, US

(21) Appl. No.: 10/200,264

(22) Filed: Jul. 22, 2002

(51) Int. Cl. B62J 7/00; B62J 9/00; B62J 11/00; A45F 4/00; A45C 15/00

(52) U.S. Cl. 224/584; 224/413; 224/427

(57) ABSTRACT

A travel bag for a motorcycle that easily and securely attaches to a variety of different size motorcycle seat backs or sissy bars has built in wheels and a collapsible/extendible handle for rolling the bag when not mounted on the motorcycle. The collapsible handle and wheels are out of the way when the bag is fastened to the motorcycle. The collapsed handle serves as a support for the bag when mounted on the motorcycle. The bag is designed to be easily opened for ready access to the inside without spilling its contents while the bag is mounted on the motorcycle.

### BACKGROUND OF THE INVENTION

1. Field of the Invention

This invention relates generally to luggage for use with motorcycles, and more specifically, to a bag that can be removably attached to a back rest of a motorcycle seat and rolled about on its own wheels when detached.

2. Description of the Related Art

A variety of different bags have been developed for attachment to a seat back or sissy bar of a motorcycle. U.S. Pat. No. 4,003,508, for example, discloses the use of a sleeve and straps on the front surface of a bag to fasten it to a sissy bar. Other fastening means, such as shown in U.S. Pat. No. D249,036 and U.S. Pat. No. D253,269 have also been used for attachment of a bag to the sissy bar of a motorcycle.

U.S. Pat. No. 3,813,018 shows another motorcycle bag and attachment scheme for attaching a collapsible luggage pouch to a passenger seat back. U.S. Pat. No. D308,916 shows a bag that is attached to a motorcycle by a pouch that fits over the seat back. U.S. Pat. No. 4,125,213 shows yet another way of fastening a bag to a motorcycle.

While much of the prior art motorcycle luggage deals with ways of fastening the bag to the motorcycle so that the structure grips the sissy bar or seat back sufficiently to prevent pivoting and windmilling when in transit, none of the prior art has contemplated the problem of transporting the bag when it is off the motorcycle, as does the present invention.

### SUMMARY OF THE INVENTION

A travel bag that can be easily and securely attached to and removed from a variety of different size motorcycle seat backs or sissy bars has built in wheels and an extendible/collapsible handle for wheeling the bag about when removed from the motorcycle. The extendible/collapsible handle collapses into a zippered pocket when not in use that also serves as a support when the bag is attached to a motorcycle seat back. The bag is designed so that it can be easily opened when mounted on the motorcycle to allow complete access to the inside without spilling the contents. The bag is fastened to the seat back or sissy bar by an adaptable fastening mechanism that can accommodate a variety of different sizes and shapes of seat back. A built-in rain cover, normally stowed in a zippered pocket of the bag, can be removed for use in inclement weather.

### BRIEF DESCRIPTION OF THE DRAWINGS

The exact nature of this invention as well as its many features and advantages will become readily apparent upon reference to the following detailed description when considered in conjunction with the accompanying drawings in which like reference numerals designate like parts throughout the figures thereof and wherein:

FIG. 1 is a perspective view showing the motorcycle bag according to the present invention fastened to a motorcycle seat back;

FIG. 2 is a perspective view of the motorcycle bag according to the present invention when it is off the motorcycle and ready to be rolled about;

FIG. 3 is a perspective view of the motorcycle bag according to the present invention showing deployment of its rain cover;

FIG. 4 is a perspective view of the motorcycle bag according to the present invention with its rain cover on, installed on the motorcycle;

FIG. 5 is a perspective view of the motorcycle bag according to the present invention showing the inside of the bag;

FIGS. 6a, 6b, and 6c are a top view of a motorcycle seat back with a preferred fastening mechanism of the motorcycle bag of the present invention located thereabout;

FIG. 7 is a perspective view of the motorcycle bag of the present invention with an alternate seat back attachment mechanism; and

FIG. 8 is a perspective view of the motorcycle bag of the present invention with yet another alternate preferred seat back attachment mechanism.

### DESCRIPTION OF THE PREFERRED EMBODIMENTS

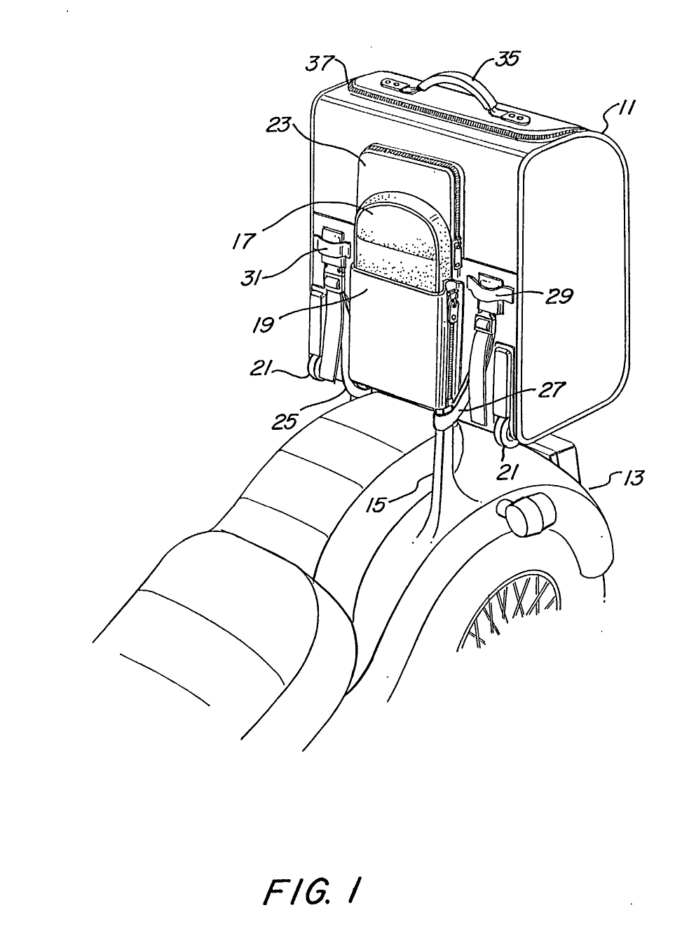

FIG. 1 illustrates a preferred embodiment of the motorcycle travel bag 11, according to the present invention, attached to a seat back 17 of a motorcycle 13 by a preferred fastening mechanism 19. The fastening mechanism 19 is attached to the front-facing surface of the bag 11. The bag 11 also has two side-facing surfaces, a top surface, and a rear-facing surface (not shown).

Besides seat back holding mechanism 19, the front-facing surface of bag 11 has a pair of straps 25, 27 attached thereto which are used to fasten the bag to extensions 15, 25 for the seat back 17. Those straps provide additional bag stability during high speed movement of the motorcycle 13.

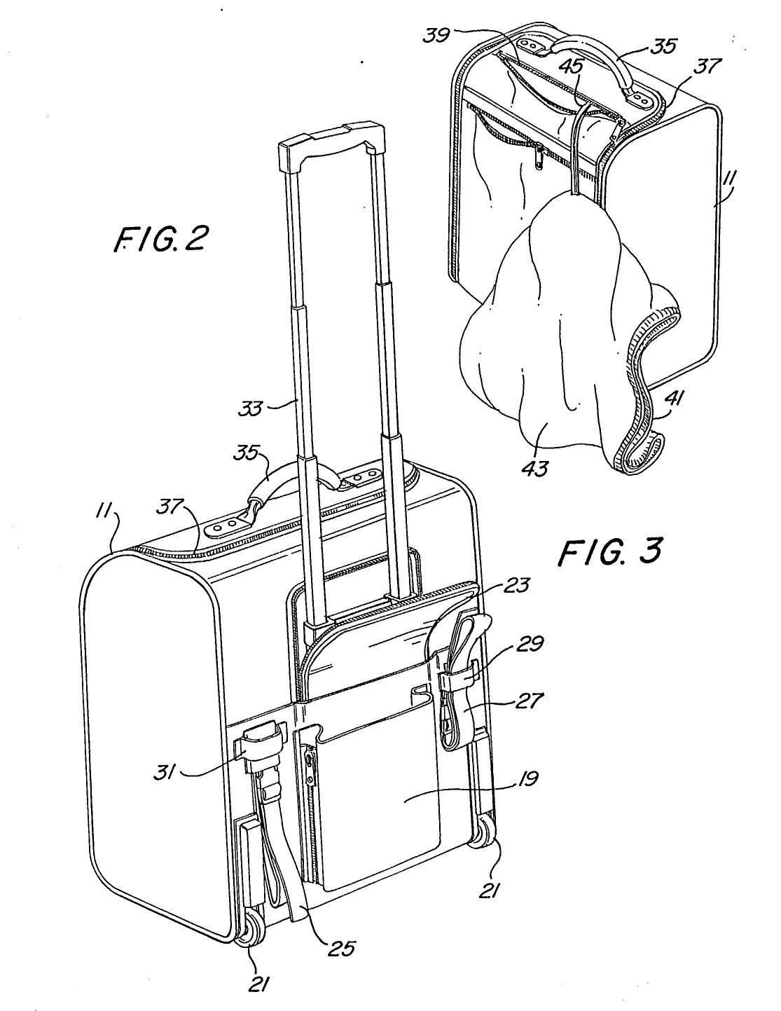

A pair of roller wheels 21, are mounted at the intersections between the front facing surface and the bottom surface of the bag 11 at the opposite side-facing surfaces. A pair of loops 29, 31, are attached to the front-facing surface of bag 11 and their use will be explained hereinafter. Contained within a zippered pocket 23 on the front-facing surface of bag 11, is an extendible, collapsible handle (FIG. 2). While in its collapsed state as shown in FIG. 1, the handle structure serves as a support for the bag 11 when fastened to the seat back 17.

FIG. 2 illustrates the motorcycle bag 11 according to the present invention removed from the motorcycle and placed on the ground ready for rolling about. The extendible, collapsible handle 33 is extended to its full length after being removed from the zippered pocket 23. The tie down straps 25, 27, are rolled up and tucked into their respective belt loops 29, 31, so they do not drag on the ground when the bag 11 is rolled on its wheels 21. As an option to rolling the bag 11, a handle 35, attached to the opening flap of bag 11, is located on the top surface of bag 11. The opening flap is shown zippered shut by zipper 37. The opening flap extends along most of the rear-facing surface of bag 11 and along a portion of the top surface of the bag 11 (FIGS. 2, 3, and 5).

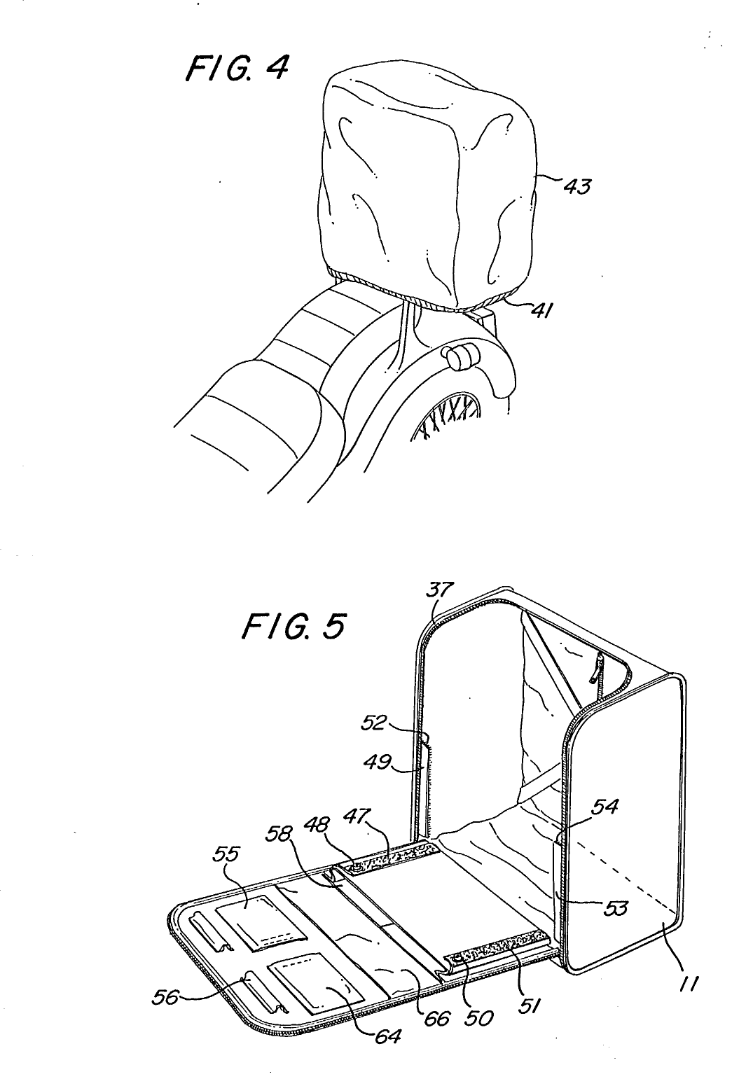

FIG. 3 illustrates the rear-facing surface of bag 11 which contains a zippered pocket 43 for maps and magazines, for example. In addition, a zippered pocket 39 contains a rain shroud 43 which is tethered to the inside of the pocket 43 by a tether 45. The shroud 43 has an elasticized edge 41 at its opened end. The elasticized edge 41 causes the shroud 43 to conform around bag 11 when in place, as shown in FIG. 4.

FIG. 5 shows the bag 11 with the access panel unzipped so as to allow the panel to fold at its base to permit complete access into the interior of bag 11. In order to prevent the goods inside from spilling out when the bag is in position on the motorcycle, a pair of Velcro hook and loop type fastening pairs 47, 49, and 51, 53, are attached respectively to the inside of the bag and the access panel. Each pair of Velcro fasteners also has a snap pair 48, 52 and 50, 54 at one end for additional holding strength. With these hook and loop fasteners in place, only the top part to about the middle of the panel will fold out, thereby preventing articles inside bag 11 from tumbling out. The inside of the access panel also has wallet and identification pockets 55, pen or pencil holders 56, and additional storage pockets 58 for bags, storage pockets 64 for cell phone or glasses and storage pocket 66 for visors or hats.

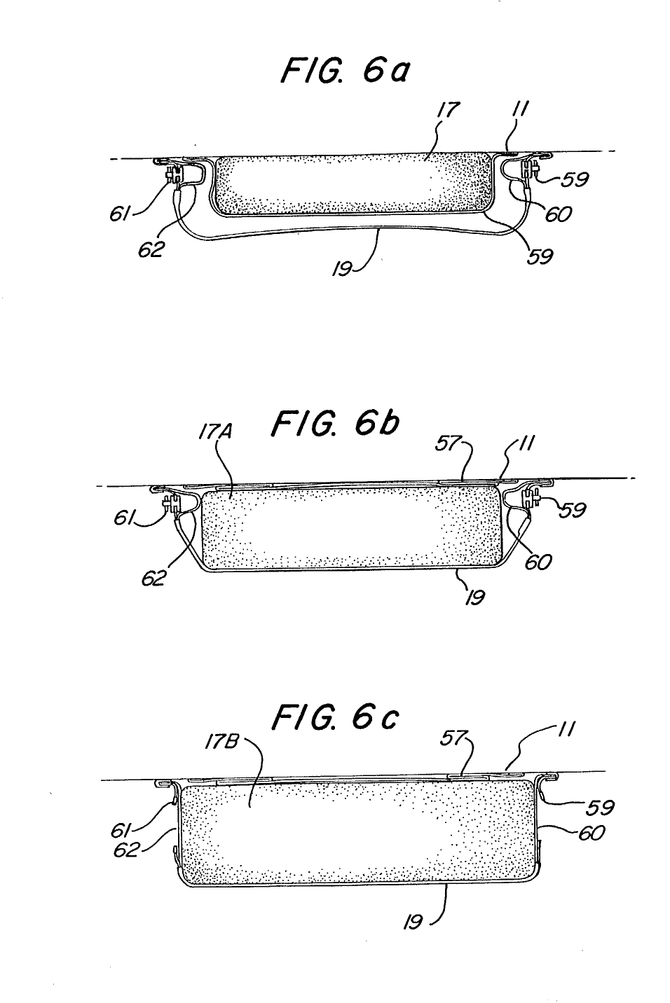

FIGS. 6a, 6b, and 6c, illustrate the flexibility of one of the motorcycle bag fastening mechanism 19 that is utilized to fasten the motorcycle bag 11 to a variety of different size seat backs 17, 17a, and 17b. This is accomplished by utilizing different sized open ended pockets 57 and 19. Open ended pocket 19 (as shown) can be extended by undoing zippers 59 and 61, either separately or together. Undoing zipper 59 allows pocket 19 to expand by strap length 60. Undoing zipper 61 allows pocket 19 to expand by strap length 62. Undoing both zippers (FIG. 6C) allows pocket 19 to expand by both strap lengths 60, 62.

The fastening mechanism of FIG. 6 is more completely illustrated and described in co-pending U.S. patent application Ser. No. 10/137,182 filed on Apr. 26, 2002 for a Motorcycle Bag by the same inventor as the present application. The entire disclosure of application Ser. No. 10/137,182 is incorporated herein by reference.

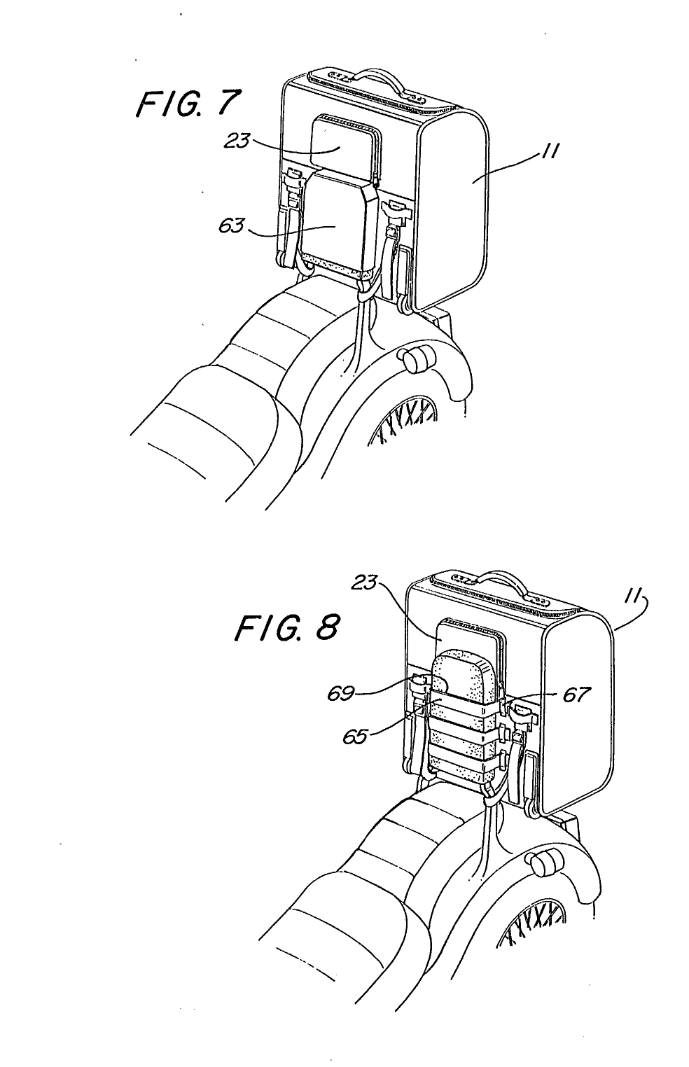

FIG. 7 illustrates an alternate seat back fastening mechanism 63 that can be advantageously used with the motorcycle bag 11 of the present invention. Seat back fastening mechanism 63 is basically a closed pocket with the opened end pointing towards the bottom surface of bag 11. This type of fastening mechanism is shown and described in greater detail in U.S. Pat. No. 5,405,068 granted Apr. 11, 1995 for Motorcycle Bag to the same inventor as the current application. U.S. Pat. No. 5,405,068 is incorporated herein by reference.

FIG. 8 illustrates yet another preferred fastening mechanism for fastening the bag 11 to the seat back of a motorcycle. The fastening mechanism shown comprises a plurality of strap pairs 65, 69, which are preferably held together by loop and hook Velcro-type fasteners. The lengths and position of these straps 65, 69, can be adjusted by passing them under respective loops 67, thereby accommodating a variety of different seat backs. A detailed description and illustration of this type of fastening mechanism can be found in U.S. Pat. No. 6,123,239 granted Sep. 26, 2000 for an Adjustable Attachment System for a Motorcycle Bag to the same inventor as the present applicant. The disclosure of U.S. Pat. No. 6,123,239 is incorporated herein by reference.

What is claimed is:

1. An improved bag for attachment to a variety of different sizes of motorcycle seat backs, the improved bag comprising:
a bag body having a bottom surface, a top surface, a rear-facing surface, a front-facing surface and two side-facing surfaces;
a means for attaching the bag to the motorcycle seat back mounted on the front-facing surface of the bag body;
a pair of wheels mounted in the bottom surface of the bag body; and
an extendible and collapsible handle attached to the front-facing surface of the bag body;
whereby the improved bag can be rolled along on its wheels by grasping the extended handle.

2. The improved bag of claim 1 wherein the pair of wheels are mounted at the intersection of the bottom surface and front-facing surface of the bag body.

3. The improved bag of claim 2 wherein the extendible and collapsible handle is mounted behind the bag attaching means.

4. The improved bag of claim 3 wherein the extendible and collapsible handle collapses into a pocket behind the bag attaching means.

5. The improved bag of claim 4 wherein the bag attaching means comprises an open ended pocket, selectively expandable to fit different width seat backs.

6. The improved bag of claim 4 wherein the bag attaching means comprises a pocket with a single opening facing towards the bottom surface of the bag body, the pocket sized to fit over the motorcycle seat back.

7. The improved bag of claim 4 wherein the bag attaching means comprises a plurality of straps aligned vertically on the front-facing surface of the bag body, each strap having a first end and a second end, the first end of each strap permanently fastened to the bag, and a fastening mechanism on the second end of each strap for fastening the second end of each strap over the seat back.

8. The improved bag of claim 1 further comprising a pair of straps, mounted on the front-facing surface of the bag body on either side of bag attaching means, for attaching the bag body to the motorcycle.

9. The improved bag of claim 8 further comprising a pair of loops mounted on the front-facing surface of the bag body on either side of the bag attaching means for tucking the straps out of the way when they are not in use.

10. The improved bag of claim 1 further comprising a rain shroud tethered to the inside of a zippered pocket on the top surface of the bag body.

11. The improved bag of claim 1 further comprising a handle fastened to the top surface of the bag body for lifting the bag body.

12. The improved bag of claim 1 further comprising a zippered map pocket located in the rear-facing surface of the bag body.

13. The improved bag of claim 1 further comprising an access panel for the bag body that encompasses most of the rear-facing surface and part of the top surface of the bag body.

14. The improved bag of claim 13 wherein the access panel is fastened to the bag body by a zipper.

15. The improved bag of claim 13 further comprising a releasable fastening means attaching a portion of the length of the access panel along its sides to the sides facing surfaces from the bottom surface to about half way to the top surface.

16. The improved bag of claim 15 wherein the access panel is fastened to the bag body by a zipper.

17. The improved bag of claim 13 wherein the inside of the access panel comprises a variety of storage pockets.

18. The improved bag of claim 17 wherein the inside of the access panel further comprises at least one pen or pencil holder.

19. The improved bag of claim 17 wherein the inside of the access panel further includes a wallet holder.

20. The improved bag of claim 17 wherein the inside of the access panel further includes a phone and eye glass holder.
